(19) United States
(12) Patent Application Publication
(10) Pub. No.: US 2025/0384102 A1
(43) Pub. Date: Dec. 18, 2025

(54) MODIFYING CONTENT USING MACHINE LEARNING

(71) Applicant: GoFundMe, Inc., Redwood City, CA (US)

(72) Inventors: Arnon KATZ, Redwood City, CA (US); Eshwar Prasad SIVARAMAKRISHNAN, Los Angeles, CA (US); Jeffrey LUONG, Long Island City, NY (US); Kelly Ann LAABS, Brooklyn, NY (US); John Mathew HARB, Pleasant Grove, UT (US); Julie Patra MILLER, Royal Oak, MI (US); Ratna SABBINENI, Northlake, TX (US); Charlotte Emily Ann DE WOLFE, Castle Rock, CO (US)

(21) Appl. No.: 19/084,575

(22) Filed: Mar. 19, 2025

Related U.S. Application Data
(60) Provisional application No. 63/661,026, filed on Jun. 17, 2024.

(51) Int. Cl. G06F 16/958; G06F 11/34; G06F 16/9538

(52) U.S. Cl. CPC G06F 16/958; G06F 11/3409; G06F 16/9538

(57) ABSTRACT

Systems and methods provide for modifying a description for an event. A description for an event and a request for modifying the description for the event is received. A query template is selected based on the request for modifying the description of the event. A query is generated using a query template for a machine learning model. A modified description for the event is received from a machine learning model which is provided for display on a website.

### CROSS REFERENCE TO RELATED APPLICATIONS

This application claims the benefit of U.S. Provisional Application No. 63/661,026, entitled “MODIFYING CONTENT USING MACHINE LEARNING,” filed Jun. 17, 2024, the disclosure of which is hereby incorporated herein in its entirety.

### TECHNICAL FIELD

This disclosure relates to generative models, and more specifically to techniques for enhancing digital content.

### BACKGROUND

Large language models (LLMs) are a type of artificial intelligence system designed to understand generate and manipulate human language. These models are built using deep learning techniques, particularly leveraging neural networks with a large number of parameters, which can process text data and learn intricate patterns in the language.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system according to aspects of the subject technology.

FIG. 3 illustrates an example computing architecture of a server according to aspects of the subject technology.

FIG. 4 illustrates an example user interface for suggesting titles according to aspects of the subject technology.

FIG. 5 illustrates an example user interface for displaying event title suggestions according to aspects of the subject technology.

FIG. 6 illustrates an example user interface for modifying user-specified event description according to aspects of the subject technology.

FIG. 7 illustrates an example user interface for modifying user-specified event description according to aspects of the subject technology.

FIG. 8 illustrates an example electronic system with which aspects of the subject technology may be implemented in accordance with one or more embodiments.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In some embodiments, structures and components are shown in block diagram form to avoid obscuring the concepts of the subject technology.

Many users initially intend to create campaigns but often find themselves unsure of what to say, leading to missed opportunities to garner support. This hesitation can stem from lack of confidence in crafting compelling messages, concerns regarding grammar and style of the messages, uncertainty regarding how to convey the urgency or importance of the campaign, or simply not knowing how to start. As a result, even those who are enthusiastic about starting a campaign might struggle to effectively describe their cause, which can significantly limit the campaign's reach and potential contributions. Furthermore, users may not be aware of the most effective way to post content regarding a given campaign and therefore may post content that is ineffective and/or suboptimal with regard to driving donors to the campaign. To overcome this challenge, the subject system can assist the users in creating a new description and a new title for describing new events which is more effective in driving donors to fundraising campaigns.

The subject system can receive a user-specified event description of the event (e.g., a message crafted by the user to promote the fundraising campaign) and a request for modifying the user-specified event description from the user device. The subject system can then incorporate the user-specified message along with one or more details of the campaign, and/or preferences of the choice of language into a query templates (or prompt templates.) These query templates include clear and concise instructions that can be used to generate queries for LLMs. The subject system then uses a LLM to process a query generated using the query template to modify the user-specified message to generate a new and/or modified description that is more effective in driving donors to fundraising campaigns. The subject system also uses the LLM to generate multiple alternative descriptions. The subject system evaluates and ranks their alignment with the campaign's objectives to select the most effective description or a set of descriptions for user review to ensure that the final description of the event when published is optimized, for example, to attract donor attention.

The subject system can also suggest titles for events. The subject system can receive a request for suggesting titles from the user device. The subject system can also receive a user-specified event title from the user device. The subject system incorporates the details of the campaigns including the user-specified title, the user-specified description, and/or the new description generated by the LLM into a query. The subject system can also incorporate details of one or more titles and/or descriptions of successful campaigns into the query. The query is then used by the LLM to either modify the user-specified title or generate multiple event titles which are then suggested to the user. The subject system can also select the most effective event titles by evaluating the event titles based on their effectiveness in engaging donor interest and their alignment with the campaign's objectives. This customization helps in connecting with particular audiences to maximize fundraising. These templates also play a role in the iterative learning and training of LLMs. The subject system can generate content for different types of campaigns using the LLMs, and gradually refine the LLMs to generate more accurate and relevant content.

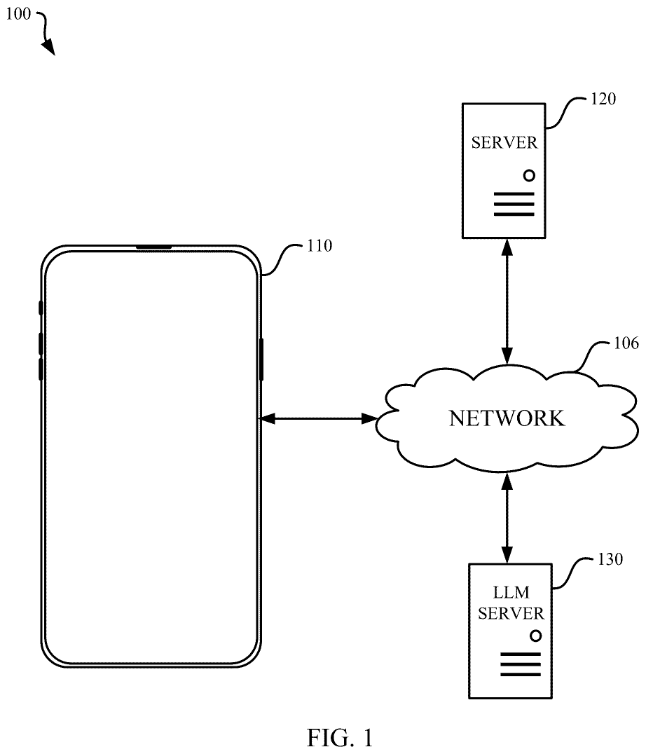

FIG. 1 illustrates an example network environment 100 in accordance with one or more embodiments of the subject technology. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 includes a user device 110 (also referred herein to as an electronic device), a server 120, and a LLM server 130. The network 106 may communicatively (directly or indirectly) couple the user device 110, the server 120 and the LLM server 130. In one or more embodiments, the network 106 may be an interconnected network of devices that may include, or may be communicatively coupled to, the Internet. For explanatory purposes, the network environment 100 is illustrated in FIG. 1 as including the user device 110, the server 120 and the LLM server 130; however, the network environment 100 may include any number of electronic devices and any number of servers.

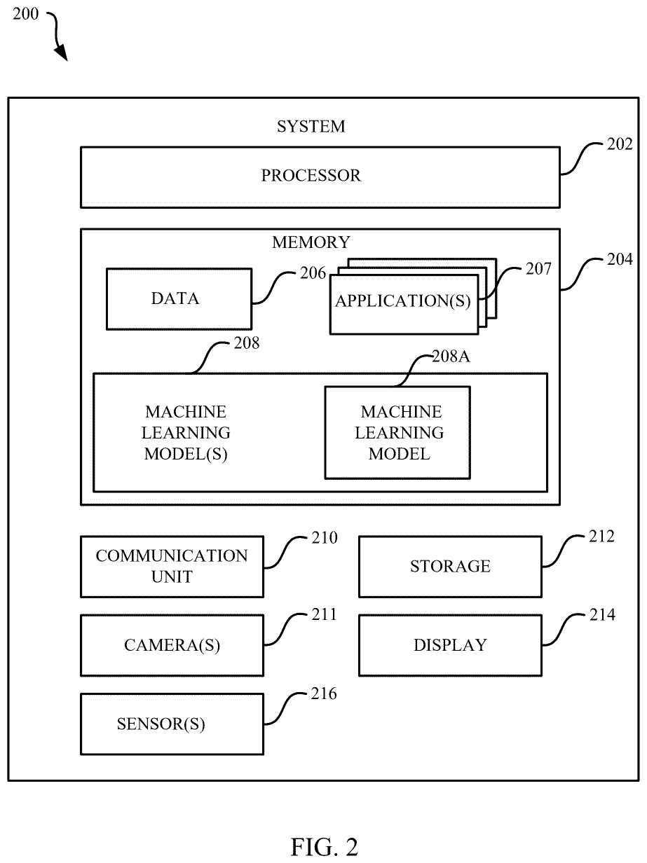

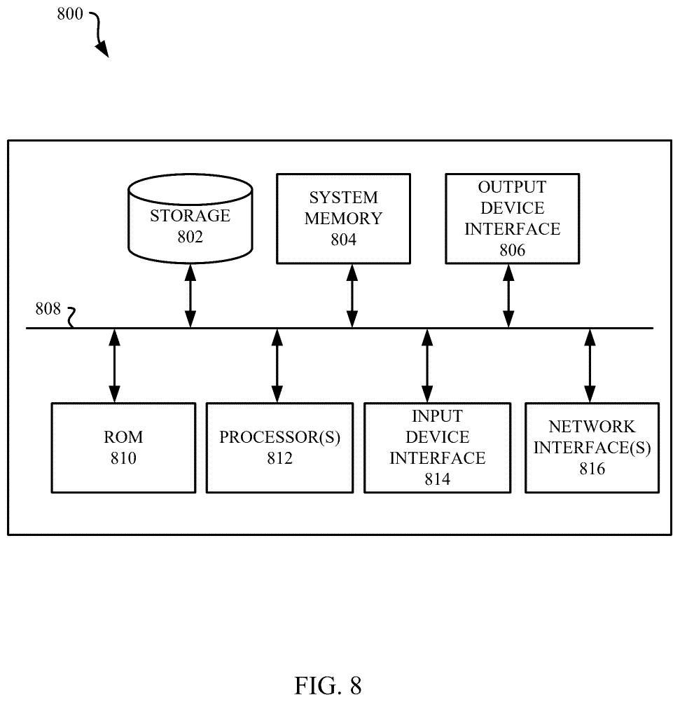

The user device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the user device 110 is depicted as a smartphone. The user device 110 may be, and/or may include all or part of, the systems discussed below with respect to FIG. 2 and/or FIG. 8.

In some embodiments, a server 120 and/or the LLM server 130 may provide a platform to train one or more machine learning models for generating digital content. In some embodiments, the server 120 and/or the LLM server 130 may provide a cloud service that utilizes the trained machine learning model and is continually refined over time. The server 120 and/or the LLM server 130 may be, and/or may include all or part of, the systems discussed below with respect to FIG. 2 and/or with respect to FIG. 8.

The server 120 can be owned or operated by an entity and may provide a catalog of types of fundraising campaigns, which may be referred to as “events,” detailing various situations that may require collective efforts for resource allocation. These events could encompass a wide range of scenarios, from health emergencies to educational initiatives, each necessitating the support and contribution of multiple individuals. Additionally, the server 120 can be a web server hosting a website that lists all of the events in the catalog. The website allows users to easily create and manage new events providing a user friendly interface for inputting detailed information of the events and track the progress of the events. In some embodiments, the server 120 can also publish one or more application programming interface (API) libraries allowing software developers to integrate the one or more functionalities described below.

In some embodiments, the server 120 may provide a framework to allow users to generate and deploy an application, such as mobile application, for a particular fundraising campaign or event. The application may present information regarding the event, such as generated using the subject system as described below, may include one or more interactive features associated with the event (e.g., games, videos, photos, etc.) and also may provide a user interface for users to donate to the event.

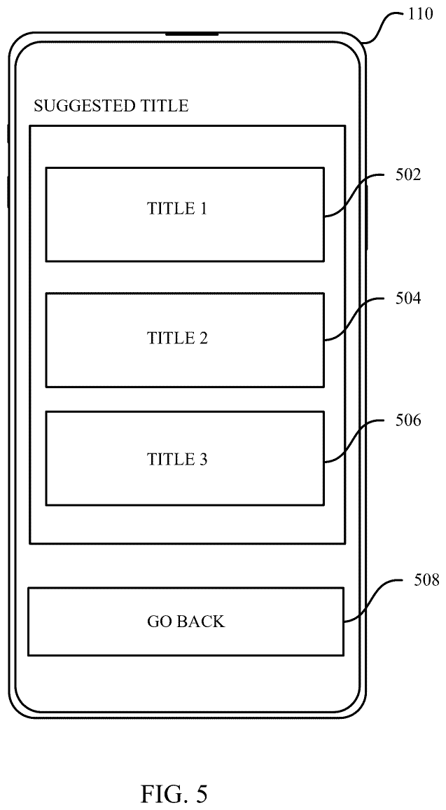

The LLM server 130 can be owned or operated by the entity or a third party technology provider that builds and provides one or more LLMs as a service (LLMaaS). The LLM server 130 may provide a platform to train one or more machine learning models such as LLMs for deployment. In some embodiments, the LLM server 130 may provide a cloud service that utilizes the trained machine learning model and is continually refined over time. The LLM server 130 may be, and/or may include all or part of, the systems discussed below with respect to FIG. 2 and/or with respect to FIG. 5.

FIG. 2 illustrates an example system 200 in accordance with some embodiments of the subject technology. In an example, the system 200 may be implemented all, or in part, in the user device 110, the server 120 and/or the LLM server 130. In another example, the system 200 may be implemented either in a single device or in a distributed manner in multiple devices, the implementation of which would be apparent to a person skilled in the art.

In an example, the system 200 may include a processor 202, memory 204 (memory device) and a communication unit 210. The memory 204 may store data 206 and one or more machine learning models 208A. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

In an example, the communication unit 210 may include one or more hardware units that support wired or wireless communication between the processor 202 and processors of other computing devices, and/or for communication over a telecommunication network.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 that are currently being executed on the system 200. The one or more applications 207 can interact with each other or with an operating system of the system 200 using application programming interfaces (API) to send or receive data. The one or more applications 207 can also include respective user interfaces (UI) to facilitate user-interaction, enabling the user to provide inputs and receive output seamlessly. For example, when implemented in the user device 110, the system 200 can execute an event sharing application that can provide a UI to receive inputs from the user of the user device 110.

As described above, the server 120 can publish a website to easily create, manage and share events on social media platforms, applications and/or third party websites, providing a user friendly interface for inputting detailed information of the events and track the progress of the events. For example, a user can create an event to highlight a shortage of blood supplies in a local hospital and spread an awareness of a blood drive aimed to collect blood to replenish the blood banks. To create a new event, the user can upload one or more images of the local hospital and update one or more attributes to describe the details of the event. In this example, the one or more attributes can include a title such as “Community Blood Drive for Local Hospitals,” a description describing the event (e.g., the campaign), a time of the blood drive, a date when the blood drive will be organized, a location (e.g., an address) where the blood drive will be organized, details of the blood drive organizers, and instructions for donors, etc.

When the user wants to create the event on the website, the user can use one or more user interface (UI) control elements on the website published by the server 120 to provide instructions to the LLM server 130 to generate a title and a description. If the user wants to generate a description for an event, the user may select an icon to provide a user-specified event description. In response to the user selection, the website can prompt the user on the user device 110 to enter a user-specified event description (e.g., a message crafted by the user to promote the fundraising campaign.) The website can keep track of the amount of the user-specified event description (e.g., number of characters, words, sentences, or paragraphs) provided by the user. By keeping track of the amount of user-specified event description, the server 120 can ensure that a pre-specified threshold of the amount of user-specified event description is met thereby providing enough data for the ML model 208A to contextually understand the user-specified event description. For example, the website can display a count of the number of characters of the user-specified event description of the event. In some embodiments, the user can also specify one or more constraints for generating the event description. For example, the user can specify the number of characters, words, or sentences for the event description. After providing the user-specified event description, the user can select another icon to generate a request for modifying the user-specified event description. The user device 110 can then transmit the user-specified event description and the request for modifying the user-specified event description to the server 120. Once the server receives the user-specified event description and the request for modifying the user-specified event description, the server 120 can initiate the process of generating a description.

The user may also want to generate a title. To do this, the user can select an icon (or a label) to generate a request for suggesting titles indicating the user's intention of receiving title suggestions. In some embodiments, the user can also provide a user-specified title. In some embodiments, the user can also specify one or more constraints such as the length of the title. For example, the user can specify the number of characters, or words for the title. The user device 110 can transmit the request for suggesting titles to the server 120. Once the server 120 receives the request for suggesting titles, the server 120 can initiate the process of generating a multiple titles for the user which are then suggested to the user. Though the following description is explained with reference to a user, it is well understood that the process of the generating event descriptions and event titles can be implemented as a batch process by the server 120 that iterates over previously collected/generated descriptions and titles to improve and update them, without requiring a human in the loop. The following describes the functioning of the user device 110, the server 120 and the LLM server 130 for generating a new description and a new title for an event.

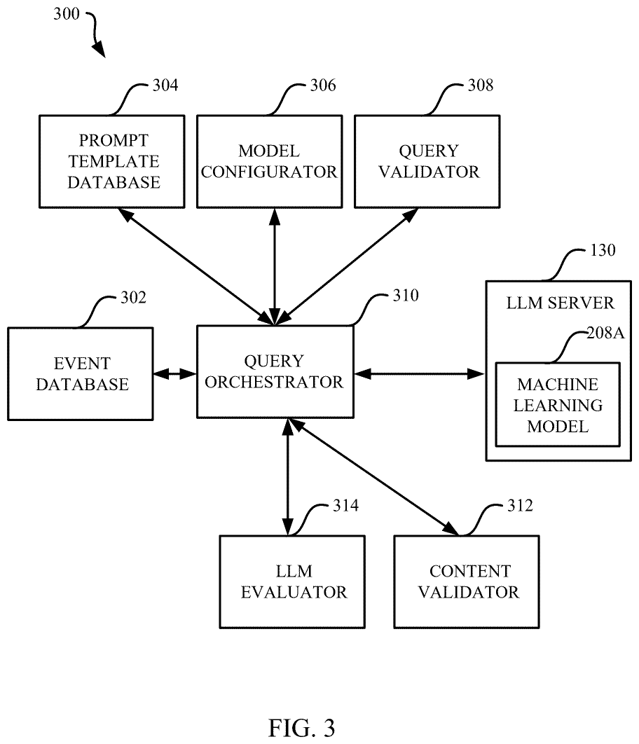

FIG. 3 illustrates an example system 300 in accordance with some embodiments of the subject technology. In an example, the system 300 may be implemented in the server 120. In another example, the system 300 may be implemented either in a single device or in a distributed manner in a plurality of devices, the implementation of which would be apparent to a person skilled in the art.

In an example, the system 300 can include an event database 302 that can store details of past and current events. The details of the events can include event title, event descriptions, one or more tags associated to the events, one or more images associated to the events, etc., specified by users who created the events. The system 300 can also include a query orchestrator 310 that selects a query template to generate a query for the LLM 208A for modifying user-specified event descriptions and titles. In some embodiments, the query orchestrator 310 can be a software agent that interacts with the LLM server 130, the ML model 208A and other components of the system 300 to provide the user of the user device 110 with event descriptions and titles using the ML model 208A. Besides query generation, the query orchestrator 310 can also interact with the user of the user device 110 via a user interface to send and receive data. For example, if the user forgets to provide a title or a description of an event, the query orchestrator 310 can request the user to provide the missing information. Additionally, the query orchestrator 310 can provide real-time suggestions for display on the user device 110 to help the user to successfully generate the request for suggesting titles or modifying user-specified event descriptions. For example, the query orchestrator 310 can analyze the user-specified event descriptions provided by the user to determine whether the user-specified event description provides sufficient context for modifying the event descriptions. For example, the query orchestrator 310 can use a machine learning model such as a locally implemented machine learning model on the server 120 to determine that the user-specified event description provided by the user includes sufficient context for modifying the user-specified description. In this example, if the query orchestrator 310 determines that the user-specified event description does not include sufficient context, the query orchestrator 310 can request the user to provide addition description of the event to ensure that the modification process of the user-specified event description is successful.

In an example, the details of the events can also include details of user-specified titles and user-specified event descriptions that were previously transmitted to the server 120 for generating the respective new titles and the new descriptions for sharing events on different social platforms. The details of the events can also include records indicating modifications performed on the user-specified titles and user-specified event descriptions by the ML model 208A to generate the respective new titles and new description. The details of the events can also include records of the new titles that were generated by the ML model 208A for suggesting titles to the user. The details of the events can also include the user selection of the social content title for the social content. The details of the events can also include the geographical location of the user, or the platform on which the event would be presented and/or distributed (e.g., social media platforms such as Facebook, X, or websites, SMS, email, etc.). The details of the events can also include an objective of the event. For example, if the event is a fundraising campaign, the objective of the campaign can include the monetary amount to be raised by the campaign. The details of the events can also include one or more tags associated with the event, such as a type or category of fundraiser. For example, if the event is a fundraising campaign for providing food to the community, the event can include tags such as “hunger,” “food,” “community” etc. As for another example, if the event is a fundraising campaign for providing books to a school, the event can include tags such as “education,” “school name,” etc.

In some embodiments, the details of the events can also include images or videos provided by the user of the user device 110. In such embodiments, a query orchestrator 310 can process the images or the videos to learn the context associated with the images and the videos. For example, assume that a user records a video of a forest fire, takes images of the damages as a result of the forest fire, and uploads the video and the images to the server 120. The query orchestrator 310 can process the video and the images (e.g., using a machine learning model) to learn the context depicted in the video and the images. In this example, the query orchestrator 310 can determine that that context is “forest fire.” In some embodiments, the query orchestrator 310 can further process the video and the images to generate a contextual description of the images and the videos. The query orchestrator 310 can use the description of the images and the videos to select a query template and generate a query for the LLM 208A. In some embodiments, the user can also specify one or more specifications of the LLM 208A. For example, the user can specify an attribute associated with the LLM 208A (sometimes referred to as “temperature”) indicating a balance between creativity and predictability of the content generated by the LLM 208A, a context window of the LLM 208A indicating a number of words considered by the LLM 208A while generating content (e.g., event descriptions and event titles), token filtering techniques, a number of tokens of the LLM 208A, etc.

In an example, the details of the events can include one or more performance metrics obtained from a social platform indicating how well the events performed when shared on the respective social platforms. The one or more performance metrics can include a number of impressions, user interactions, click-through rate (CTR), conversion rates, etc. For example, impressions measure the total number of times the content is displayed, while user interactions track direct engagements such as likes comments and shares. CTR indicates the effectiveness of the content in making users to take actions and conversion rate measures how many users complete a desired action such as donating or signing up for a newsletter after interaction with the content, etc. The one or more performance metrics of the content can also include the total funding received in response to sharing the content on the social platform. In an example, the one or more performance metrics are obtained by tracking the users visiting the website. For example, the one or more performance metrics such as the number of impressions, the user interactions, the click-through rate (CTR), the conversion rates, etc., can be computed by the server 120 publishing the website by monitoring the activity of the users on the website.

In an example, the system 300 can include a query template database 304 that can store multiple query templates. A query template is set of instructions for formulating input queries for the ML model 208A. Each query template in the query template database 304 can include multiple placeholders which can be used to insert information regarding the events to generate queries that are relevant to the event.

In an example, the system 300 can include a model configurator 306 responsible for updating and storing one or more settings of the ML model 208 and the LLM server 130. These setting can include a version of the ML model 208A, an application programming interface (API) of the ML model 208A, an internet protocol (IP) address of the LLM server 120, a port number for the ML model 208A and/or a Uniform Resource Locator (URL) of the ML model 208A, etc. If the user specifies one or more specifications of the LLM 208A, the model configurator 306 can select a version of the ML model 208A based on the specifications. For example, if the user has specified the number of tokens, the model configurator 306 can select a version of the ML model 208A that operates using the user specified number of tokens in the vocabulary.

In an example, the system 300 can include a query validator 308 that can validate the query generated by the server 120. The query validator 308 can evaluate the query to validate whether the query is safe, efficient, and/or adhering to protocols set by the server 120 and the LLM server 130. In an example, the system 200 can further include a query orchestrator 310 that generates a query based on the query template for the ML model 208A. In an example, the system 300 can include a content validator 312 to validate the content generated by the ML model 208A. The content validator 312 can evaluate the content generated by the ML model 208A for safety and relevancy. In an example, the system 300 can also include a LLM evaluator 314 that can evaluate the relevancy of the content and the query templates. The LLM evaluator 314 can further initiate a re-training process of the ML model 208A.

In some embodiments, each query template in the query template database 302 can be specific to a particular task. For example, a query template can be used to instruct the ML model 208A to process a user-specified event description, and the details of an event to modify the user-specified event description to generate a new description. As for another example, a query template can be used to instruct the ML model 208A to process the details of the event to generate one or more new titles.

In some embodiments, the server 120 receives a user-specified event description of an event, an indication of the event and a request for modifying the user-specified event description from the user device 110. In response, the server 120 can initiate a query generation process. In some embodiments, the query orchestrator 310 can select a query template based on the request for modifying the user-specified event description received from the user device 110.

In some embodiments, the query orchestrator 310 can facilitate the LLM 208A by guiding the LLM to perform targeted tasks by generating multiple queries to address one or more tasks specified by the request. In such embodiments, the query orchestrator 310 can evaluate the request to generate one or more tasks for completing the request. In such embodiments, the query orchestrator 310 can use the event database 302 to store previously executed requests and the respective responses from the LLM 208A including evaluation results based on the performance of the past events. For example, assume that the request includes a pointer (e.g., a description) of a prior event. The query orchestrator 310 can access the event database 302 to retrieve information associated with the prior event. The query orchestrator 310 can then select one or more details (e.g., event description, event title, etc.,) of the prior events to include in the query template to generate a query for the LLM 208A.

In some embodiments, the query orchestrator 310 can obtain one or more settings of the ML model 208 and the LLM server 130 from the model configurator 306. The query orchestrator can include these one or more settings in portions (e.g., placeholders) specified by the query template. Examples of the one or more settings can include a model identifier of the ML model 208A, a model version of the ML model 208A, an application programming interface (API) specific to the identified model, a destination address of the LLM server 130 which may include an internet protocol (IP) address, URL, port number, etc.

In some embodiments, after selecting the query template and obtaining the one or more settings of the ML model 208A and the LLM server 130, the query orchestrator 310 can use the user-specified event description, the selected query template, the details of the identified event, and the settings of the ML model 208A to generate a query. For example, a query template may specify a first portion (e.g., placeholder) to include the user-specified event description, a second portion to include the event title, a third portion to include the event description, a fourth portion to include the one or more settings of the ML model 208A and the LLM server 130, etc. In some embodiments, the query orchestrator 310 can process the user-specified event description, the details of the identified event, and the settings of the ML model 208A prior to generate a compressed representation. The query orchestrator 310 then incorporates the compressed representation into the selected query template.

In some embodiments, the query orchestrator 310 can identify one or more events that were previous shared on the social platform based on the performance metrics associated with the events. For example, the query orchestrator 310 can identify one or more events from the event database with the highest performance metrics. For example, the query orchestrator 310 can identify one or more events that had the highest conversion rates when shared on the social platform. As for another example, the query orchestrator 310 can identify one or more events that the received the maximum amount in donations when shared on the social platform. As for another example, the query orchestrator 310 can identify one or more events based on a combination of multiple performance metrics obtained after being shared on the social platform. For example, the query orchestrator 310 can use a ranking model (e.g., a ML model, an algorithm, or a heuristic model) to process multiple performance metrics of the events to determine a ranking of the events based on how well they performed when shared on the social platform. Based on the rankings, the query orchestrator 310 can identify the one or more events that were successful after sharing on the social platform. For brevity, the one or more of events are collectively referred to as successful events.

In some embodiments, the query orchestrator 310 can identify one or more events based on the performance metrics computed by the server 120 by monitoring the activity of the users on the website. For example, the query orchestrator 310 can identify the one or more events that received the maximum amount in donations by users vising the website.

In some embodiments, the query orchestrator 310 can incorporate the successful events into the selected query template so as to provide the ML model 208A with a positive reinforcement to improve the ML model's 208 generative capacity. For example, the query orchestrator 310 can incorporate the details of the successful events including the user-specified event descriptions and the new descriptions that was generated by the ML model 208A. By doing so, the ML model 208A can evaluate the one or more examples of events to learn intricate patterns and relationships between the one or more events and the respective new descriptions.

In some embodiments, the query orchestrator 310 can incorporate instructions for the ML model 208A into the query template specifying the process the details of one or more examples of events that were successful. For example, the query orchestrator 310 can include instructions for ML model 208A to perform N-shot learning. By doing so, the ML model 208A can evaluate the one or more examples of events to learn intricate patterns and relationships between the one or more events and the respective new descriptions.

In some embodiment, the query orchestrator 310 can specify constraints for generating the event descriptions. In such embodiments, the query orchestrator 310 can include those constraints into the query template for generating the event description. For example, the query orchestrator 310 can specify constraints such as a maximum number of characters, words, or sentences for the event descriptions. In this example, the query orchestrator 310 can include these constraints into the query template to instruct the ML model 208A to generate event descriptions that adhere to the constraints. In some embodiments, the query orchestrator 310 can also resolve any discrepancies between the constraints specified by the user and those defined by the query orchestrator 310 itself. For example, if the user specifies that an event description should have a minimum length of 1000 characters, but the query orchestrator 310 imposes a maximum length of 800 characters, the query orchestrator 310 can prioritize its own constraints and include those into the query template.

In some embodiments, after generating the query, the query validator 308 can validate the query to ensure that the inputs are valid, safe, efficient, and adhering to protocols. To validate the generated query, the query validator 308 can for example, check if the generated query is correctly formatted, safe, and likely to produce meaningful and appropriate responses from the ML model 208A. As an example, the query validator 308 can perform a basic validation to check whether the query follows the expected syntax and format specified by the LLM server 130 and/or the ML model 208A. This may include checking for grammatical mistakes, punctuations, and structure of the query. The basic validation may further include validating the length of the query. For example, if the length of the query is less than a pre-specified threshold, the query validator 308 can notify the query orchestrator 310 and in response, the query orchestrator 310 can include additional details of the event to meet the pre-specified threshold.

In some embodiments, the query validator 308 can perform a semantic validation of the query. For example, the query validator 308 can check whether the generated query has clarity and no ambiguity, reducing the likelihood of generating confusing and irrelevant response from the ML model 208A. In some embodiments, the query validator 308 can perform one or more security validations by detecting and mitigating potential injection attacks or harmful inputs that are designed to exploit the vulnerabilities of the ML model 208A. The security validations can also include content validations to remove hate speech and explicit material ensuring that such inputs are not processed by the ML model 208A.

Other validations performed by the query validator 308 can include performance optimization to ensure that the complexity of the query is below a certain threshold so that the ML model 208A can process the query efficiently without overloading the LLM server 130. Other validations performed by the query validator 308 can further include regulatory compliance to ensure that the query meets the relevant regulations and standards such as General Data Protection Regulation (GDPR) for data privacy or specific industry guidelines.

In some embodiments, after validating the query, the server 120 transmits the query to the LLM server 130. After receiving the query from the server 120, the LLM server 130 can uniquely identify the ML model 208A based on the one or more settings of the ML model 208A that was included in the query. After identifying the ML model 208A, the LLM server 130 provides the query as input to the ML model 208A. The ML model 208A can process the successful events that were included in the query to learn the intricate patterns and relationships between the details of the successful events, the respective user-specified descriptions and the respective new description that was used to share the event. The ML model 208A can then process the details of the event and the user-specified event description to modify the user-specified event description to generate a new description. In some embodiments, the new description can be a textual content. However, in other embodiments, the new description can be a multimedia content such as images, videos, emojis, stickers or a combination of different content types.

In some embodiments, modifying the user-specified event description can include checking for grammatical errors such as subject-verb agreement, tense consistency, spelling mistakes and proper use of articles and prepositions. Modifying the user-specified event description can also include refining the user-specified event description by enhancing coherence, structure, and style of the user-specified event description. Modifying the user-specified event description can also include rephrasing awkward or unclear sentences, eliminate redundancies, and ensure that the text follows a logical progression. Modifying the user-specified event description can also include refining stylistic elements to maintain consistency such as adjusting the level of formality to suit the target audience or aligning the tone to match the context. Modifying the user-specified event description can also include generating new content to replace the user-specified event description to generate the new description. Modifying the user-specified event description can also include emphasizing portions of the user-specified event description and/or portions of the newly generated content. By doing so, the ML model 208A can ensure that the new description not only conveys the intended message effectively but also resonates with the reader, making is engaging and impactful.

In some embodiments, the ML model 208A can generate multiple event descriptions in response to executing the query. After receiving the descriptions, the query orchestrator 310 can select the most effective descriptions by ranking the descriptions based on their estimated effectiveness in driving donors to the event. To rank each description, the query orchestrator 310 can evaluate the descriptions using predefined criteria, including relevance to the event objectives, clarity of messaging, emotional impact on the target audience. Evaluation can include an estimated potential of the descriptions to engage and motivate donor action. In some embodiments, evaluation of the descriptions can be performed using sentiment analysis. In other embodiments, the evaluation of the descriptions can be performed using the alignment of descriptions towards successful historical events. For example, the query orchestrator 310 can generate a vector of features by processing the event descriptions and compute the alignment (e.g., cosine similarity) to feature vectors of historical events obtained from the event database 302. In such embodiments, the similarity of an event description with prior successful events can be used a metric to estimate the potential of the event descriptions. Once evaluated, the query orchestrator 310 can rank their performances using different evaluation metrics. In some embodiments, the query orchestrator 310 can select an event description with the highest rank. In other embodiments, the query orchestrator 310 can select a set of event descriptions based on their rank or estimated performances and transmits the set of event descriptions to the user device 110 for presentation to user. For example, if the ML model 208A generated ten event descriptions, the query orchestrator 310 can select three event descriptions with the highest estimated performances.

In some embodiments, after receiving the new description, the query orchestrator 310 can use the content validator 312 to validate the new description received from the LLM server 130. The social content validation can include evaluating the new description to ensure quality, safety, and relevance of the new description. For example, the content validator 312 can perform a semantic validation of the new description to ensure that the new description is relevant and meaningful in relation to the query. This can include a relevancy check to verify that the new description directly addresses the query. The validation query can also include a coherency check to determine whether the new description is logically consistent and follows a coherent narrative.

In some embodiments, the content validator 312 can perform a syntax and grammar validation to ensure that the new description is free from grammatical mistakes. If the content validator 312 determines grammatical mistakes in the new description, the content validator 312 can use grammar correcting tools to remove the errors. In some embodiments, the content validator 312 can also perform a security validation to determine whether the new description does not include harmful or malicious content. For example, the content validator 312 can check whether the new description includes hate speech, or objectionable content such as images depicting blood, violence, nudity, etc. If the content validator 312 determines that the new description includes harmful content, the content validator 312 can update the new description to remove the harmful content. For example, if a new description is an image that depicts blood, the content validator 312 can blur the portion of the image depicting blood. After updating the new description, the content validator 312 can again perform the one or more validations described above to ensure quality, safety, and relevance of the updated new description.

In some embodiments, the content validator 312 can check whether the event descriptions generated by the ML model 208A meet the constraints that were specified by the user or the query orchestrator 310. For example, the content validator 312 can check whether the number of characters, words or sentences of the event descriptions are according to the constraints that were included in the query template by the query orchestrator 310. In such embodiments, if the event descriptions do not meet the user specified constraints or constraints specified by the query orchestrator 310, the query validator 312 can notify the query orchestrator 310. In response, the query orchestrator 310 can re-transmit the query to the ML model 208A notifying the ML model 208A of the constraints that were not met. In other embodiments, the query orchestrator 310 can update the query to enforce the constraints. For example, the query orchestrator 310 can assign weights to the constraints in the query, so as to make the ML model 208A generate new event descriptions according to the specified constraints.

In some embodiments, after validating the new description, the server 120 can transmit the new description to the user device 110 for displaying the description on the user device 110. If the user approves the new description, using one or more controls of the website, the user device 110 can transmit the request for modifying the user-specified event description for display on the website. In such embodiments, the new description is transmitted to the website and the new description is presented in a preview mode using a UI of the website.

The user may also want to generate a title for the new description. As described above, the user can select an icon (or a label) indicating the user's intention of receiving title suggestions. In some situations, the user can also provide a user-specified title. The user device 110 can transmit the request for suggesting titles to the server 120.

In some embodiments, the server 120 receives an indication of the event and a request for suggesting titles from the user device 110. In response, the server 120 can initiate a query generation process. In some embodiments, the query orchestrator 310 can select a query template based on the request for suggesting titles received from the user device 110.

As described above with reference to modifying the user-specified event description, the query orchestrator 310 can obtain one or more settings of the ML model 208 and the LLM server 130 from the model configurator 306. The query orchestrator 310 can include the one or more settings in portions (e.g., placeholders) specified by the query template. These one or more setting can specify the configuration of the ML model 208 that would be used to generate the new title. Examples of the one or more settings can include a model identifier of the ML model 208A, a model version of the ML model 208A, an application programming interface (API) specific to the identified model, a destination address of the LLM server 130 which may include an internet protocol (IP) address, URL, port number, etc. In some embodiment, the query orchestrator 310 can also specify constraints for generating the titles. For example, the query orchestrator 310 can specify the maximum length of the title. In such embodiments, the query orchestrator 310 can include those constraints into the query template for generating the new titles to instruct the ML model 208A to generate titles that adheres to the constraints specified by the query orchestrator 310.

As described above with reference to modifying the user-specified event description, the query orchestrator 310 can use the selected query template, the successful events, the details of the identified event, and the settings of the ML model 208A to generate a query. After generating the query, the query validator 308 can validate the query using similar techniques described with reference to validating the query for modifying the user-specified event description. After validating the query, the server 120 transmits the query to the LLM server 130. After receiving the query from the server 120, the LLM server 130 can uniquely identify the ML model 208A based on the one or more settings of the ML model 208A that was included in the query. After identifying the ML model 208A, the LLM server 130 provides the query as input to the ML model 208A. The ML model 208A can process the successful events that were included in the query to learn the intricate patterns and relationships between the details of the successful events, the new titles that were generated by the ML model 208A. The ML model 208A can then process the details of the event to generate new titles for the identified event. In some embodiments, the new titles can be a textual content. However, in other embodiments, the new titles can be a multimedia content such as images, videos, emojis, stickers or a combination of different content types.

The generated titles are then transmitted to the server 120. After receiving the titles, the query orchestrator 310 can use the content validator 312 to validate the titles using techniques described with reference to validating the event descriptions generated by the ML model 208A. For example, the content validator 312 can check whether the titles generated by the ML model 208A adheres to the constraints that were specified by the user or the query orchestrator 310. If one or more titles do not meet the specified constraints, the query validator 312 can notify the query orchestrator 310. In response, the query orchestrator 310 can re-transmit the query to the ML model 208A notifying the ML model 208A of the constraints that were not met. In other embodiments, the query orchestrator 310 can update the query to enforce the constraints. For example, the query orchestrator 310 can assign weights to the constraints in the query, so as to make the ML model 208A generate new titles according to the specified constraints.

After validating the new titles, the server 120 can select a set of titles and transmit the set of titles to the user device 110 for displaying them it on the user device 110 as suggestions. The query orchestrator 310 can evaluate the titles using predefined criteria, including relevance to the event objectives, clarity of messaging, emotional impact on the target audience. Evaluation can include an estimated potential of the titles to engage and motivate donor action. In some embodiments, evaluation of the titles can be performed using sentiment analysis. In other embodiments, the evaluation of the titles can be performed using the alignment of titles towards successful historical events. For example, the query orchestrator 310 can generate a vector of features by processing the event titles and compute the alignment (e.g., cosine similarity) to feature vectors of historical events obtained from the event database 302. In such embodiments, the similarity of an event title with successful events (e.g., titles of successful events) can be used a metric to estimate the potential of the event titles. The selected titles are then transmitted to the user device 110. If the user selects a title, using one or more controls of the website, the user device 110 can transmit an indication of providing the selected title for display on the website.

In some embodiments, the user can also provide user-specified title. In such embodiments, the query orchestrator 310 can also incorporate the user-specified title into the selected query template. In such embodiments, the ML model 208A can process the user-specified title to generate one or more new titles based on the user-specified title or modify the user-specified title to generate a new title using techniques described with reference to generating the social content generator.

In some embodiments, the server 120 can use the LLM evaluator 314 to continuously monitor the performance metrics of the social content on the website. The LLM evaluator 314 can query the website to obtain one or more performance metric such as the number of impressions, the user interactions, click-through rate (CTR), conversion rates, etc. For example, impressions measure the total number of times the content is displayed, while user interactions track direct engagements such as likes comments and shares. CTR indicates the effectiveness of the social content in making users to take actions and conversion rate measures how many users complete a desired action such as donating or signing up for a newsletter after interaction with the social content, etc. In some embodiments, the one or more performance metrics of the social content can also include the total funding received in response to sharing the social content on the social platform. After determining the performance metrics of the social content, the LLM evaluator 314 can store the performance metrics in the event database 302.

In some embodiments, the server 120 can provide a feedback to the LLM server 130 and/or the ML model 208A. For example, after determining the performance of the event, the query orchestrator 310 can transmit the query, the event titles generated by the LLM 208A, the event descriptions generated by the LLM 208A, the user selected event titles, the user selected event descriptions and the performance of the event to the LLM server 130. In response to receiving the feedback, the LLM server 130 can adjust the weights of the ML model 208A to align its predictions to the user selected event titles and descriptions based on the performance of the event. For example, if the event is successful, the LLM server 130 can adjust the weights of the ML model 208A to align its predictions to the user selected event titles and descriptions. However, if the event is not successful, the LLM server 130 can adjust the weights of the ML model 208A to align its predictions to certain portions of the user selected event titles and descriptions so as to only incorporate user preferences but still maintain its prediction alignment based on historical events.

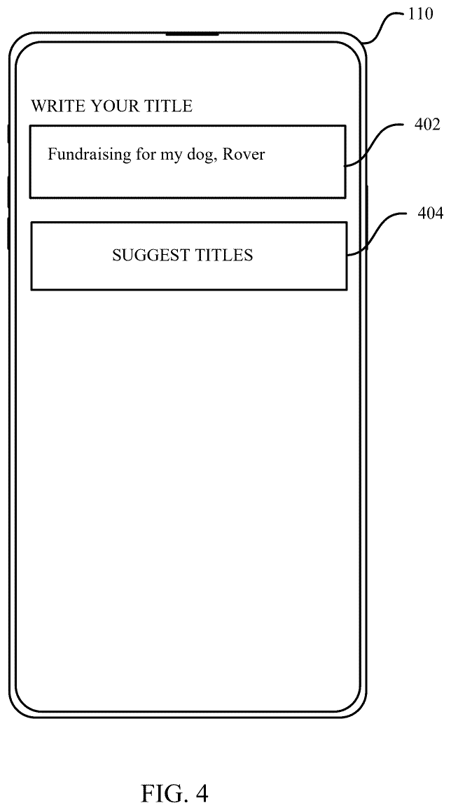

FIG. 4 shows an example UI for generating one or more new titles. The user device 110 can include an application such as web-browser to access the website published by the server 120. As described above, the user may also want to generate a title for the new description or the user-specified event description. The user can select an icon (or a label) indicating the user's intention of receiving title suggestions. In some situations, the user can also provide a user-specified title. With reference to FIG. 4, the user can use a text box 402 to provide the user-specified title and use the control element such as the clickable button 404 to generate a request for suggesting titles.

FIG. 5 shows an example UI for displaying the one or more new titles on the user device 110. As described before, the server 120 can transmit the one or more new titles to the user device 110 for displaying them it on the user device 110 as suggestions. With reference to FIG. 4, the new titles 503, 504 and 506 are displayed on the display screen of the user device 110. The user can select a new title by interacting with the user device 110 (e.g., by touching the display screen) and generate the indication of the selected title and the indication (e.g., notification) of providing the selected title for display on the website The user also has an option of going back to the UI described with reference to FIG. 4 by interacting with clickable button 508.

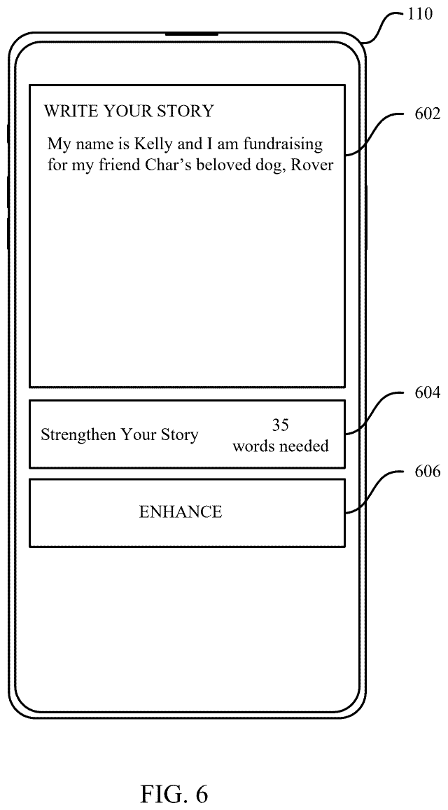

FIG. 6 shows an example UI for modifying the user-specified event description. The user can enter the user-specified event description using the text box 602. The website can keep track of the amount of user-specified event description entered by the user. For example, the website shows that the user has to enter thirty five more words to meet the pre-specified threshold of the amount of user-specified event description. After entering the user-specified event description, the user can interact with the clickable button 606 to generate a request for modifying the user-specified event description.

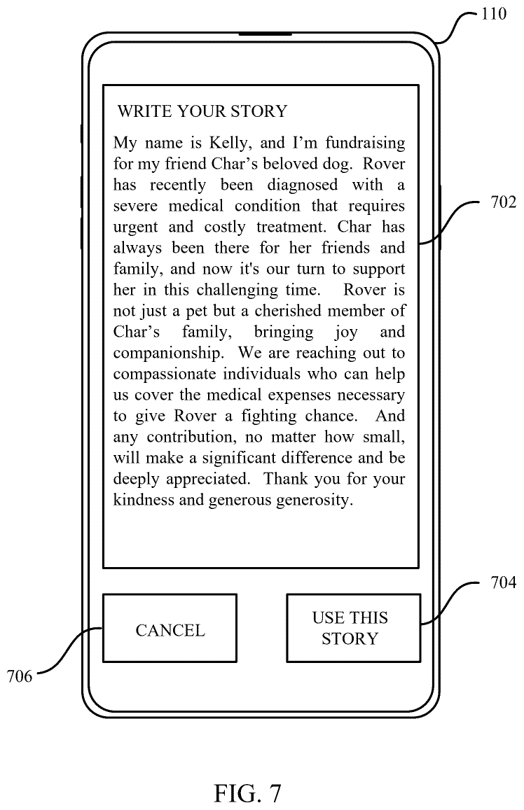

FIG. 7 shows an example UI for displaying the modifying the user-specified event description on the user device 110. The new description is displayed on the display prompt 702. The user can interact with the clickable button 704 to use the new description for generating the request for modifying the user-specified event description for display on the website. The user can also interact with the clickable button 706 if the user decides to not use the new description.

FIG. 8 illustrates an electronic system 800 with which one or more embodiments of the subject technology may be implemented. The electronic system 800 can be, and/or can be a part of, server 120, LLM server 130, and/or user device 110 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more embodiments, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 1012 can be a single processor or a multi-core processor in different embodiments.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more embodiments, a mass-storage device (such as a magnetic or optical disk and its corresponding disk drive) may be used as the permanent storage device 802.

In one or more embodiments, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random-access memory. The system memory 804 may store any of the instructions and data that one or more processing unit(s) 812 may need at runtime. In one or more embodiments, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more embodiments.

The bus 808 also connects to the input and output device interfaces 814 and 806. The input device interface 814 enables a user to communicate information and select commands to the electronic system 800. Input devices that may be used with the input device interface 1014 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the user device 110 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 1000 can be used in conjunction with the subject disclosure.

Embodiments within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some embodiments, one or more embodiments, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method comprising:
receiving a description of an event and a request for modifying the description for the event;
selecting a query template based in part on the request for modifying the description;
generating, using the query template, a query for a machine learning (ML) model based on the description of the event;
providing the generated query to the ML model and, responsive thereto, receiving a plurality of modified descriptions for the event generated by the ML model for a website;
selecting a modified description of the event from the plurality of modified descriptions; and
providing, for display on the website, the modified description of the event on the website.

2. The computer-implemented method of claim 1, further comprising:
transmitting the modified description of the event to a user device for displaying the modified description of the event on the user device; and
receiving an indication from the user device for providing the modified description of the event for display on the website.

3. The computer-implemented method of claim 2, wherein generating the query for a ML model comprises:
selecting one or more past events based on a performance of each event of the one or more past events;
selecting the event descriptions of each of the one or more past events; and
incorporating the event descriptions of each of the one or more past events and the description of the event into the query template.

4. The computer-implemented method of claim 3, wherein selecting the one or more past events comprises:
determining a respective performance metric for each event in a plurality of past events; and
selecting the one or more past events from the plurality of past events, the one or more past events having the respective performance metric greater than a pre-specified threshold.

5. The computer-implemented method of claim 1, wherein selecting the modified description of the event from the plurality of modified descriptions comprises selecting the modified description of the event based in part on an estimated performance of the modified description.

6. A computer-implemented method comprising:
receiving an indication of an event and a request for suggesting titles;
selecting a query template based in part on the request for suggesting titles;
generating, using the query template, a query for a machine learning (ML) model based on a description of the event;
providing the generated query to the ML model and, responsive thereto, receiving a plurality of new titles for the event generated by the ML model for a website; and
providing, for display on the website, a selected title from among the plurality of new titles generated for the event for the website.

7. The computer-implemented method of claim 6, further comprising:
transmitting to a user device for displaying the plurality of new titles on the user device; and
receiving an indication of the selected title from among the plurality of new titles; and
receiving an indication for providing the selected title for display on the website.
